(19) United States
(12) Patent Application Publication
(10) Pub. No.: US 2017/0357894 A1
(43) Pub. Date: Dec. 14, 2017

(54) DATA PACKING FOR CONVOLUTION OF ARTIFICIAL NEURAL NETWORKS

(71) Applicant: Apple Inc., Cupertino, CA (US)

(72) Inventors: Eric Bainville, Sunnyvale, CA (US); Ali Sazegari, Los Altos, CA (US)

(73) Assignee: Apple Inc., Cupertino, CA (US)

(21) Appl. No.: 15/619,348

(22) Filed: Jun. 9, 2017

Related U.S. Application Data
(60) Provisional application No. 62/348,802, filed on Jun. 10, 2016.

(51) Int. Cl. G06N 3/08; G06F 3/06

(52) U.S. Cl. CPC G06N 3/08; G06F 3/064; G06F 3/0626; G06F 3/0673

(57) ABSTRACT

Convolution processing performance in digital image processing is enhanced using a data packing process for convolutional layers in deep neural networks and corresponding computation kernel code. The data packing process includes an input and weight packing of the input channels of data into a contiguous block of memory in preparation for convolution. In addition, data packing process includes an output unpacking process for unpacking convolved data into output channel blocks of memory, where the input channel block and output channel block sizes are configured for efficient data transfer and data reuse during convolution. The input packing and output packing processes advantageously improve convolution performance and conserve power while satisfying the real-time demands of digital image processing.

### CROSS-REFERENCE TO RELATED APPLICATION

This application claims the benefit of an earlier filed provisional application, application Ser. No. 62/348,802, entitled DATA PACKING FOR CONVOLUTION OF BINARIZED NEURAL NETWORKS filed on Jun. 10, 2016.

### BACKGROUND

Artificial Neural Networks (NN) are used in digital image processing for deep learning or machine learning tasks such as image recognition, object detection and the like. The NN is trained to perform these various image processing tasks using convolution weights. After being trained, the digital image processor applies the weights to the image data using convolution.

Convolution is a linear mathematical process to combine two inputs to produce an output. In the context of digital image processing, convolution of one pixel in a two-dimensional image is a linear combination of the neighboring pixels. Thus, to obtain one pixel of output using a 3×3 binary weight requires 9 multiplications and 9 additions, or 18 floating point operations=18 flops per pixel.

In vision applications, the application of a weight to a two-dimensional image uses multi-layered convolution (MLC). The input is a stack of channels, e.g. 100 channels, representing corresponding image layers. Performing 18 flops per pixel requires 1,800 flops just to obtain one pixel of output for one output channel. The output also has 100 channels (order of magnitude). Thus, the entire image requires W×H×180,000 flops. So for 3k to 4k images, the processor would need to perform 2.16 times 10¹² flops, or about 10 seconds on a 2-core MAC processor.

For this reason, the computational load of convolution has a great impact on the processing core of the device in which it is being used. For devices running on battery power, convolution can cause the processor to consume significant amounts of energy. Thus it is important to design convolution processes to be as high-performance as possible, not only to satisfy the real-time demands of digital image processing, but also to conserve battery power.

### SUMMARY OF THE DESCRIPTION

Methods, processes, apparatus, machine-readable tangible storage media, and data processing systems are described to reduce processor demand during convolution using data packing.

In one embodiment, data packing reduces processor demand during convolution through any one or more of reducing a number of load and store operations and reusing data already in close proximity to the processor.

In one embodiment data packing includes input data packing and output data packing. Input data packing includes pre-processing input data representing a digital image signal into an input channel block of contiguous memory. Output data packing includes convolving the input data representing the digital image signal into an output channel block of contiguous memory sized in accordance with an architecture of the convolution processor.

In one embodiment, pre-processing input data includes determining a size of the input channel block into which the input data is packed, wherein the size of the input channel block depends on the size of the output channel block, and further wherein the size of the output channel block depends on the architecture of the convolution processor.

In one embodiment, determining the size of the input channel block into which the data is packed further includes determining how many neighboring pixels in the digital image signal are to be used during convolution.

In one embodiment, preprocessing input data includes arranging multiple input channel blocks into contiguous memory for multi-layer convolution.

In one embodiment, convolving the input data representing the digital image signal into an output channel block of contiguous memory sized in accordance with an architecture of the convolution processor includes processing packed input data from the input channel block with a convolution kernel to produce output data packed into the output channel block, the output data representing the convolved digital image signal.

In one embodiment, processing packed input data from the input channel block with the convolution kernel includes transferring in a single load as many pixels from the input channel block as fill the available registers depending on the architecture of the convolution processor, and applying the convolution kernel to the register content until convolution is complete, and transferring the convolved content of the registers to the output channel block.

In one embodiment, applying the convolution kernel to the transferred pixels filling the available registers until convolution is complete includes processing each weight vector of a weight matrix sized in accordance with the architecture of the convolution processor and calculating register values containing an accumulation of a product of each weight vector with the values of the registers until all weight vector products have been accumulated.

In one embodiment, processing packed input data from the input channel block with the convolution kernel is repeated until all pixels from the input data packed into the input channel block have been transferred to the available registers and convolved.

Other features of the present invention will be apparent from the accompanying drawings and from the detailed description that follows.

### BRIEF DESCRIPTION OF THE DRAWINGS

The present invention is illustrated by way of example and not limitation in the figures of the accompanying drawings, in which like references indicate similar elements and in which:

FIG. 1 is a block diagram illustrating exemplary components of a system to reduce processor demand during convolution using data packing in accordance with an embodiment of the invention;

FIGS. 2 through 4 are flow diagrams illustrating certain aspects of a process logic for data packing in accordance with an embodiment of the invention;

FIGS. 5A-5G illustrate an example of certain aspects of convolution using data packing in accordance with an embodiment of the invention; and

FIG. 6 illustrates an example of a typical computer system that can be used in implementing a system to reduce processor demand during convolution using data packing in accordance with an embodiment of the invention.

### DETAILED DESCRIPTION

Methods, processes, apparatus, machine-readable tangible storage media, and data processing systems for reducing processor demand during convolution using data packing are described herein. In the following description, numerous specific details are set forth to provide thorough explanation of embodiments of the present invention. It will be apparent, however, to one skilled in the art, that embodiments of the present invention may be practiced without these specific details. In other instances, well-known components, structures, and techniques have not been shown in detail in order not to obscure the understanding of this description.

Reference in the specification to “one embodiment” or “an embodiment” means that a particular feature, structure, or characteristic described in connection with the embodiment can be included in at least one embodiment of the invention. The appearances of the phrase “in one embodiment” in various places in the specification do not necessarily all refer to the same embodiment.

The processes depicted in the figures that follow, are performed by processing logic that comprises hardware (e.g. circuitry, dedicated logic, etc.), software (such as is run on a general-purpose computer system or a dedicated machine), or a combination of both. Although the processes are described below in terms of some sequential operations, it should be appreciated that some of the operations described may be performed in different order. Moreover, some operations may be performed in parallel rather than sequentially.

Unlike most convolution processing, embodiments of the present invention facilitate reducing processor demand during convolution using data packing. Data packing provides a number of advantages when processing an input channel with a convolution kernel. Aside from performance advantages, data packing allows the processing tasks that depend on convolution, such as character and face recognition and other feature discrimination tasks, obtain results in near real-time while conserving power consumption and preserving the battery life of the device in which the convolution processes are carried out.

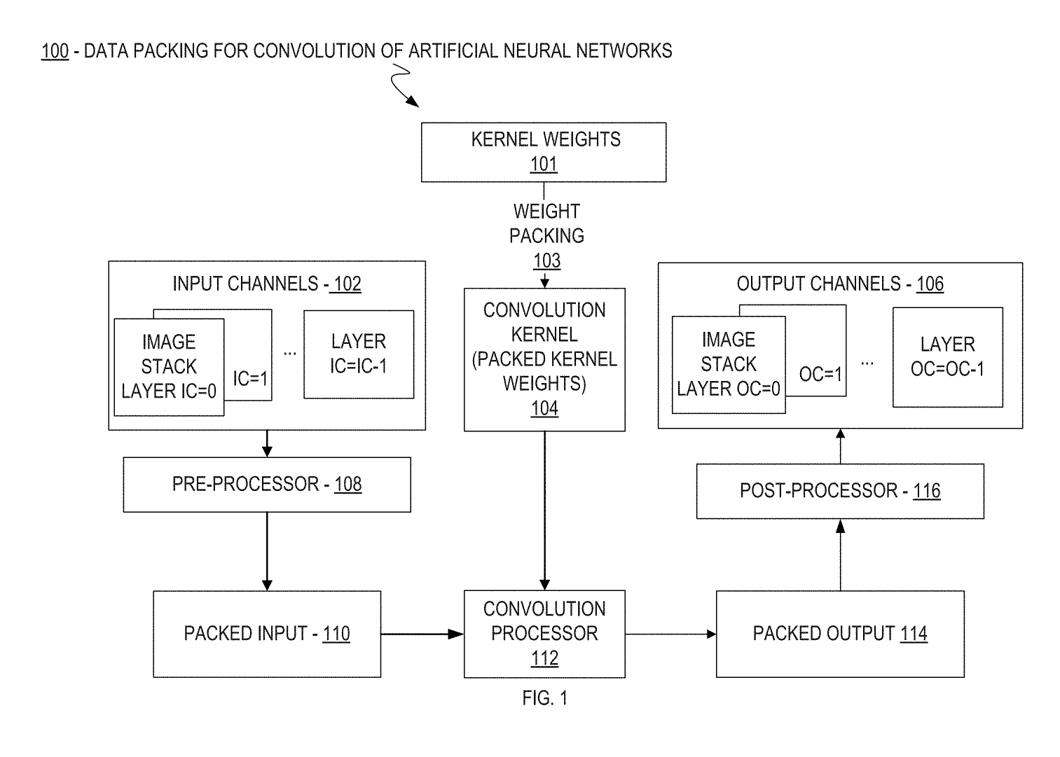

FIG. 1 is a block diagram illustrating exemplary components of a system for reducing processor demand during convolution using data packing. As illustrated, input channels 102 contain multiple layers 1 to IC=Input Channel images also referred to as an image stack. Output channels 106 likewise contain multiple layers 1 to OC=Output Channel images referred to as an image stack, and further wherein the content of the output channels is convolved from the input channels through the application of a convolution kernel 104. In general, the number of IC is not equal to the number of OC.

In one embodiment, the convolution kernel 104 is a predetermined set of weights obtained during training a neural network for such tasks as character or face recognition, or other type of task associated with digital image processing. The set of weights are typically in the form of a weight matrix having a dimension associated with the task for which it was trained.

In one embodiment, a pre-processor component 108 processes the image stack contained in the input channels to generate packed input 110. The packed input 110 is contained in an input channel block to contain as much of the image stack of data as is needed to insure that the pipeline of data needed for convolution is continuous and to reduce the convolution processor 112 demands during convolution. In one embodiment, the pre-processor 108 processing includes weight packing 103 to pack kernel weights 101 into packed convolution kernel weights 104, where the weight matrix is packed to match the order of computation induced by the packed input 110.

In one embodiment, the convolution processor 112 loads contiguous portions of the packed input 110 into the convolution processor's registers and performs convolution on the loaded portions of the packed input 110 using packed weight vectors taken from the weight matrix of the convolution kernel 104. The content of the registers is then transferred to the packed output 114 for generating the output channel 106 via post-processor 116.

In one embodiment, the convolution processor 112 continues processing until all of the packed input 110 has been processed and transferred to the packed output 114 for generating output channel 106. In this manner, data packing for convolution reduces the processing load of the convolution processor by reducing a number of load and store operations used to transfer the portions of packed input 110 to the registers of the convolution processor 112 and reusing the data already in close proximity to the processor to perform the convolution.

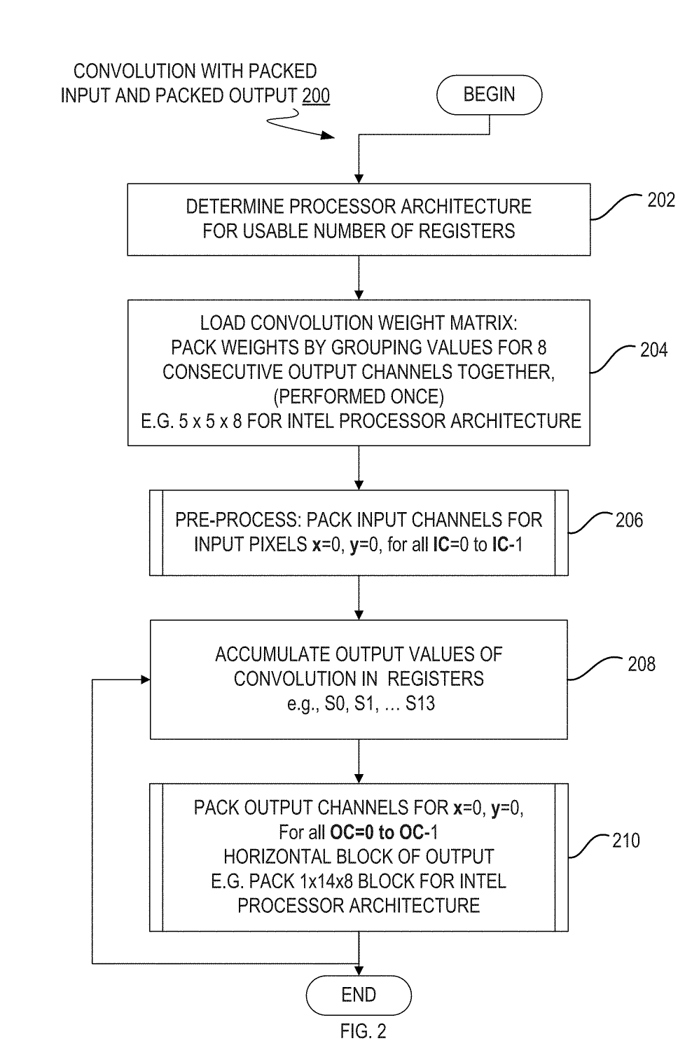

FIGS. 2 through 4 are flow diagrams illustrating certain aspects of a data packing process logic 200 for performing convolution with packed input and packed output. In the illustrated embodiment of FIG. 2, at process block 202, the data packing logic determines the processor architecture on which the convolution processor is operating to ascertain a usable number of registers. By way of example only, certain Intel processors can provide 14 registers for convolution processing; other types of processors might provide greater or fewer registers.

In one embodiment, at process block 204, in order to prepare for convolution, a packed convolution weight matrix is loaded. In one embodiment, weight vectors taken from the weight matrix also depend on the architecture of the processor. By way of example only, for an Intel processor for a 5×5 weight matrix, the weight vectors are 5×5×8, in which case the weights are packed by grouping values for 8 consecutive output channels together, performed once prior to convolution. In one embodiment, other processors may use weight vectors that are 5×5×4, in which case the weights are packed accordingly.

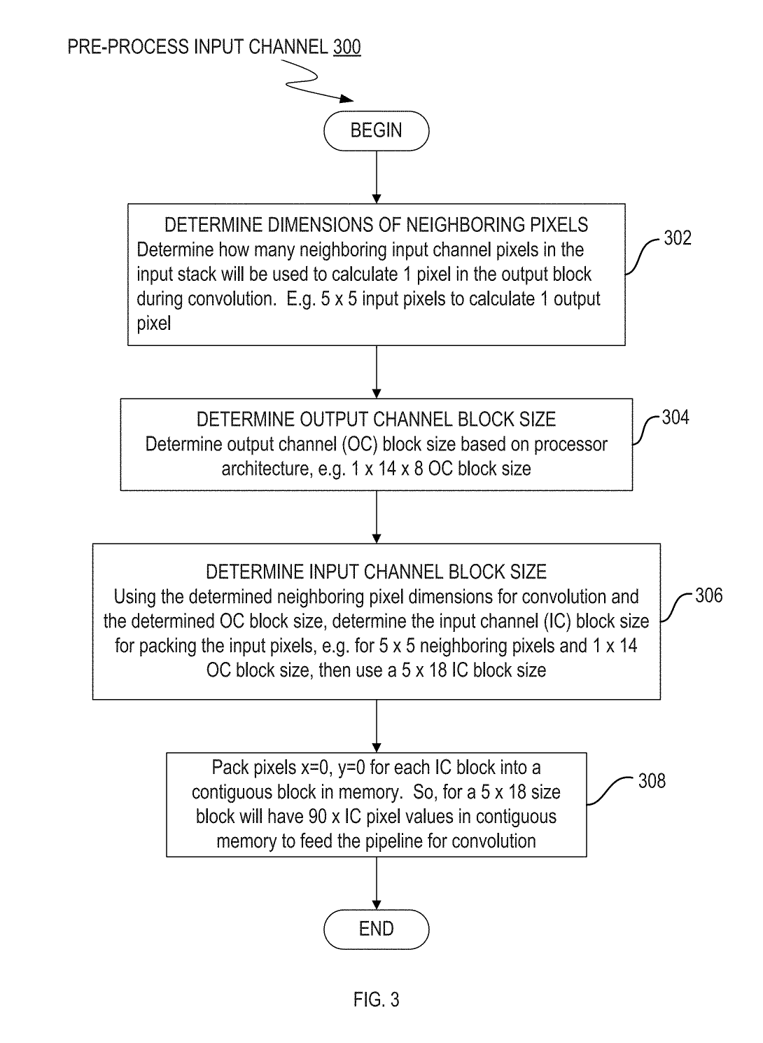

In one embodiment, data packing performs a pre-processing logic at 206 as will be described in further detail in FIG. 3, in which the input channels are packed for input pixels x=0, y=0 of the stacked images for all input channels IC=0 to IC−1.

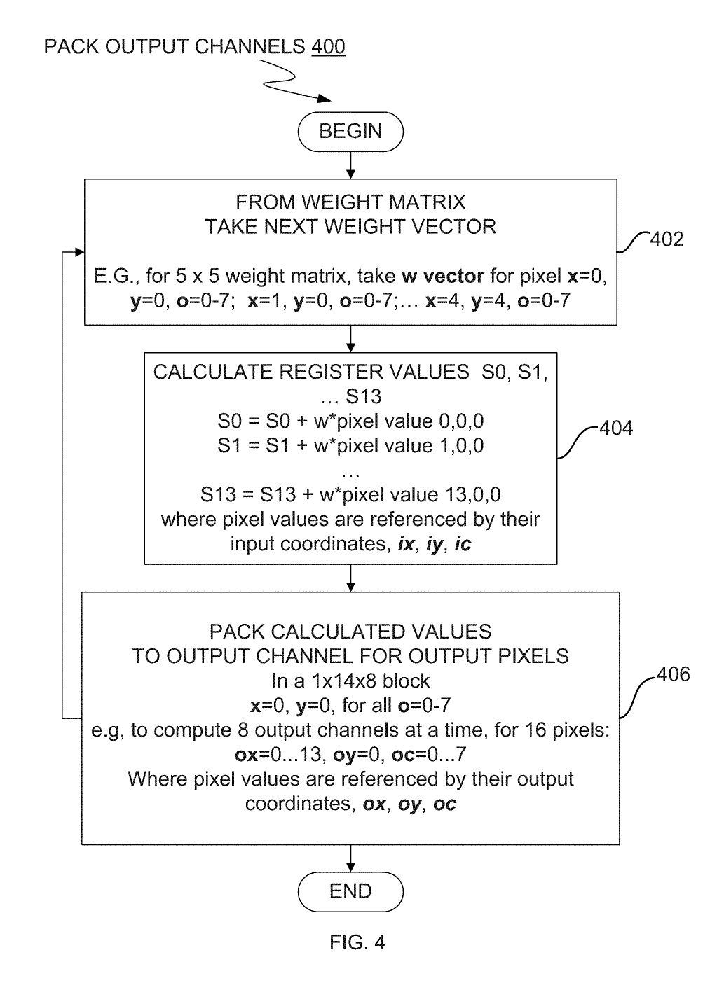

In one embodiment, data packing logic for convolution concludes with a pack output channels logic at 210 as will be described in further detail in FIG. 4. In one embodiment, data packing logic for convolution begins a processing routine at 208 in which the output values of convolution are accumulated into registers, e.g. registers S0, S1, . . . S13.

The output packing logic performs the convolution processing on the loaded registers using the weight vectors taken from the weight matrix and transfers the contents to an output channel block. The size of the output channel block matches the number of available registers and the weight vector dimensions such that upon conclusion of the convolution processing the contents of the registers may be efficiently transferred and packed into the output channel block. For example, in one embodiment, the size of the output channel block is 1×14×8 for a horizontal block of output pixel data for the output channel.

FIG. 3 illustrates in further detail certain aspects of pre-processing the input channel in preparation for convolution processing with data packing. In one embodiment, the pre-processing logic 300 begins at 302 to determine the dimensions of the neighboring pixels. In one embodiment, how many neighboring pixels are used to calculate each pixel in the output block can vary depending on the convolution task at hand. For example, the neighboring pixels could be a 5×5 block of input pixels surrounding a single input pixel or a 3×3 block, or the like.

In one embodiment, at 304 the processing logic 300 determines the output channel block size based on the convolution processor architecture, such as the 1×14×8 output channel block size referenced in FIG. 2 at 206. At 306, based on the determinations at 302 and 304, the processing logic determines the input channel block size for packing the input pixels for subsequent convolution processing. For example, for packing input pixels being convolved with 5×5 neighboring pixels and a 1×14 output channel block size, then the input channel block size will be 5×18. The input channel block size of 5×18 accommodates 90 pixels per input channel×the number of input channels for packing in contiguous memory to feed the pipeline for convolution.

FIG. 4 illustrates in further detail certain aspects of packing the output channel during convolution processing with data packing. In one embodiment, at 402, a processing loop is initiated for convolution beginning with taking a weight matrix vector w for convolution of the portion of input pixels that have been transferred to the convolution registers. For example, for a 5×5 weight matrix, take w vector for pixel x=0, y=0 at output channel 0, o=0; x=1, y=0, o=0; . . . ; x=4, y=4, o=0, where the w vector=kx, ky, wOC, where OC is the number of output channels being processed, processing starts at the 0 channel and continues up to the wOC channel, and the wOC value depends on the convolution processor architecture, e.g. 4 or 8 output channels.

In one embodiment, at 404, register values for registers S0, S1, . . . , S13 are updated using convolution by applying the weight vector to each pixel value until all of the weights have been applied, and accumulating the results of each application of the weight vectors in the respective registers. In one embodiment, at 406, upon completion of the convolution processing, the calculated values in registers S0, S1, . . . , S13 are packed into output channel block 1×14×8, and the process is repeated until all of contents of the packed input channel block have been convolved and packed into the corresponding output channel block.

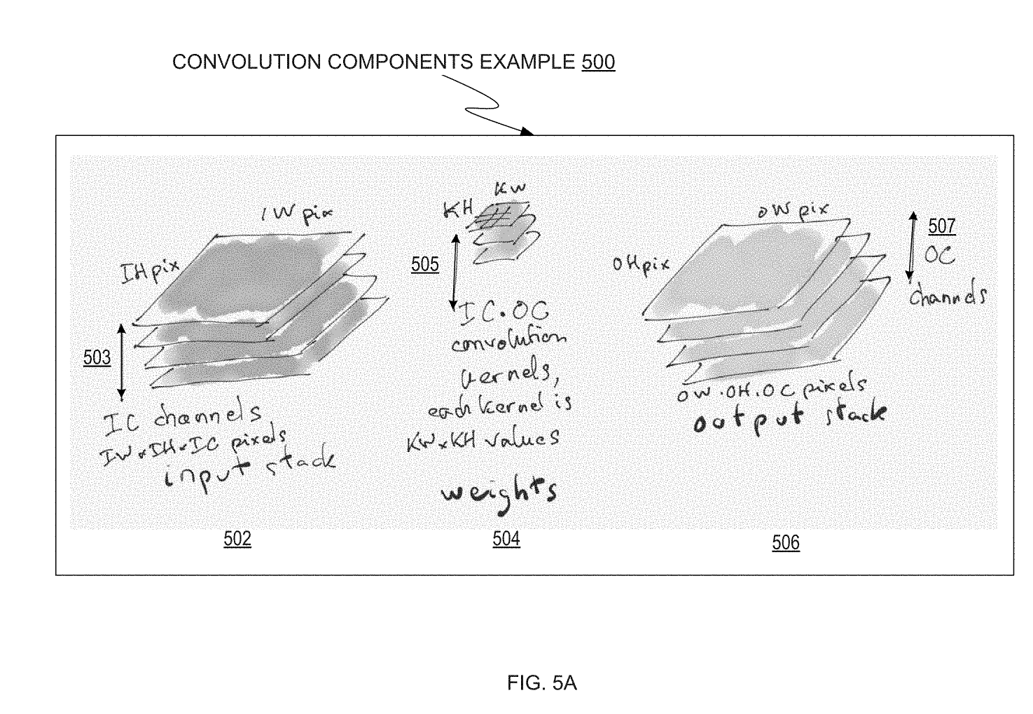

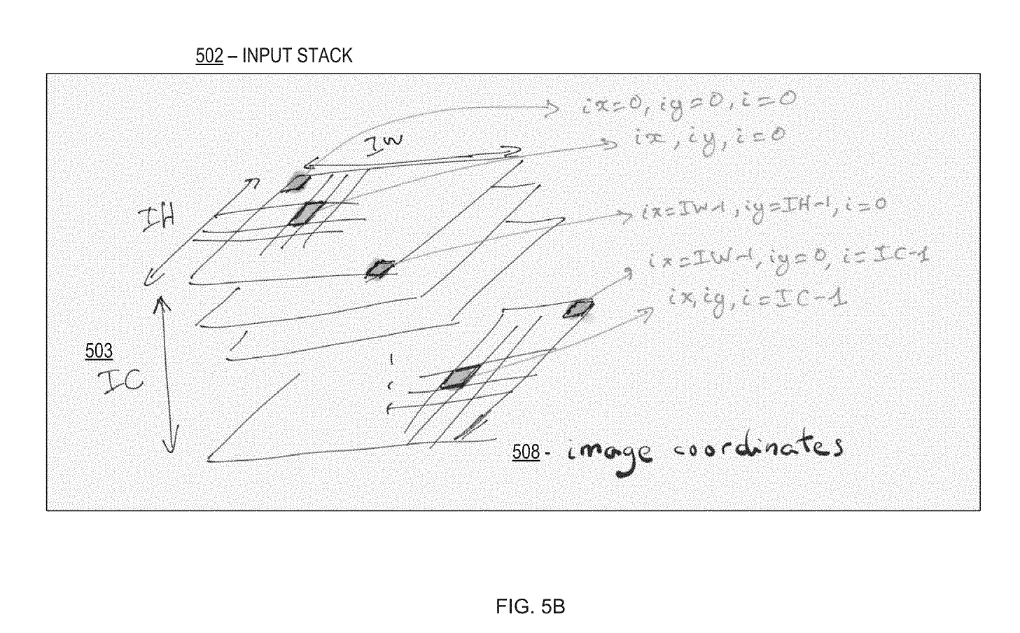

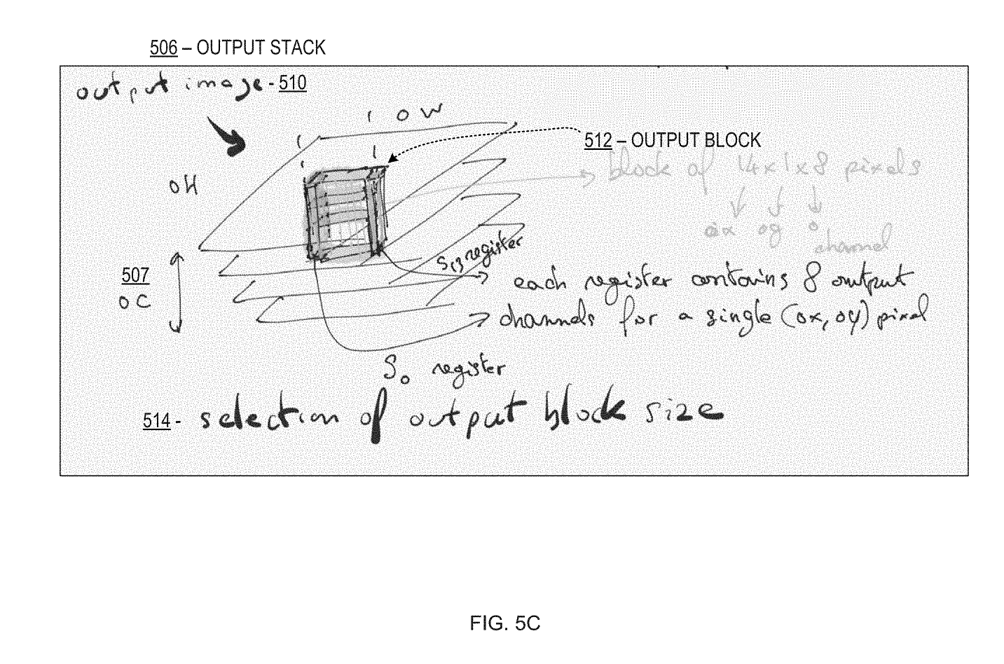

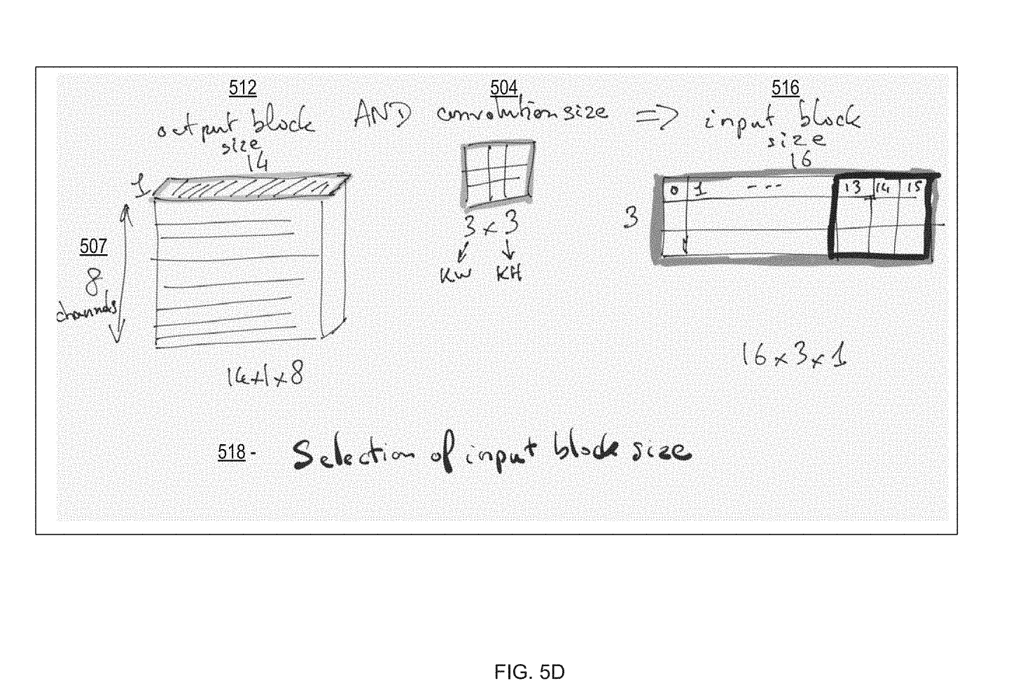

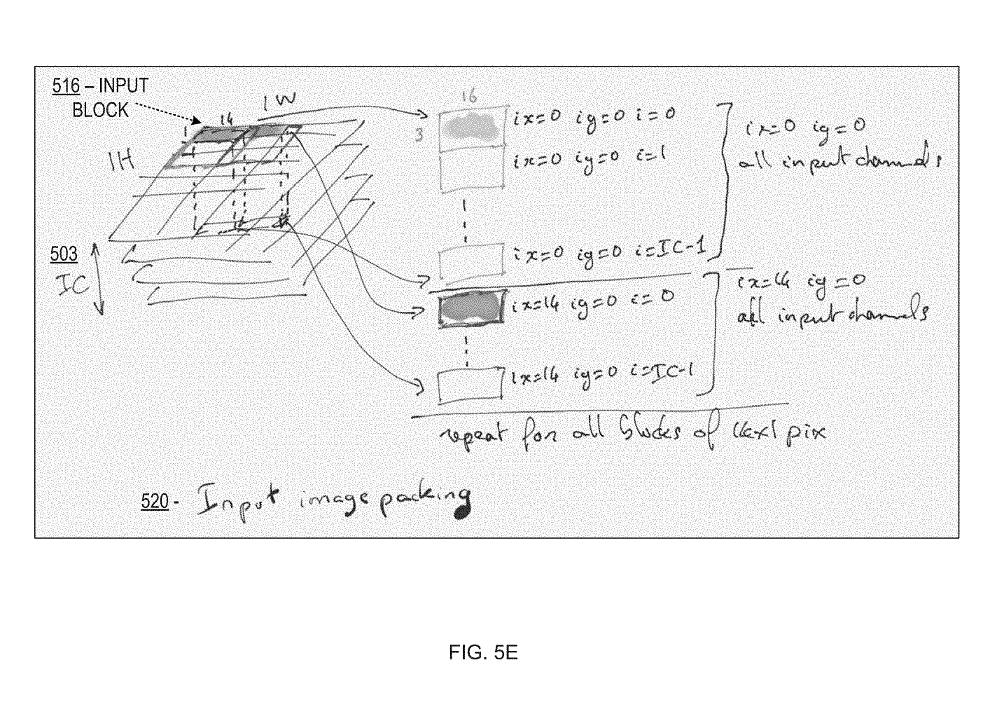

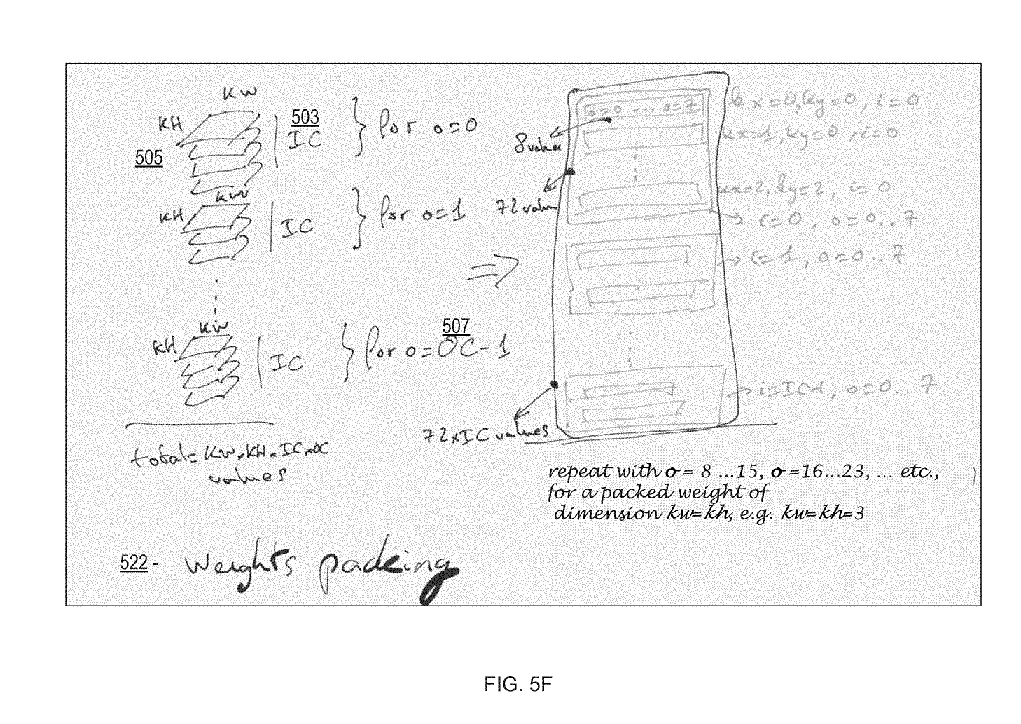

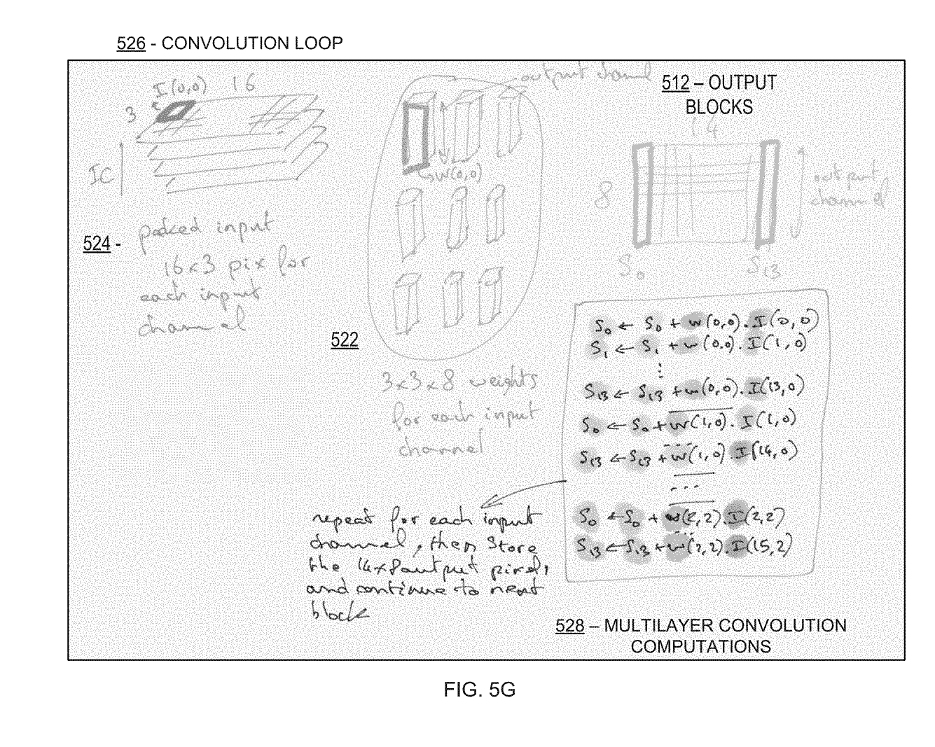

FIGS. 5A-5G illustrate an example scenario of convolution with data packing in which a convolution kernel having 3×3 dimensions is used to convolve 3×16 input channel blocks of input pixel data into a 1×14 output channel blocks of data. As illustrated in the figures, the weight vectors w=kx, ky, wOC operate on the input channel data for input channels I=0 to IC−1, and loaded into convolution registers a portion at a time, using multi-layer convolution. A multi-layer convolution is performed by multiplying the input channel pixels IC(0,0), IC(1,0), . . . , IC(2,2) by the corresponding weighted value pixels W(0,0), W(1,0), . . . , W(2,2), and accumulating the results into a single block of output channel pixels, OC(1, 0), . . . , OC(1, 13). The process is repeated until all of the packed input channel data has been processed, resulting in a packed output channel block size of dimensions 1×14×8 for transfer to output channels 0=0 to OC-1.

As shown in FIG. 5A, the convolution components example 500 includes a) an input stack 502 having IC channels 503 for an image of IH pixels by IW pixels, b) convolution weights 504 having IC·OC convolution kernels 505, where each kernel has kh by kw values, and c) an output stack 506 having OC channels 507 for an image of OH by OW pixels. OW=IW−kw+1, and OH=IH−kh+1. Example values are as follows: When OW=OH=42 pixels, the OC=96 channels, kw=kh=3, IW=IH=44 (OW=42, kw=3, and 42+3−1=44), and the IC=64 channels.

FIG. 5B illustrates additional detail of the input stack 502, with examples of how the image coordinates are specified for each pixel in each channel, where the first channel is the 0 channel and the last channel is the IC-1 channel, and the x-y coordinates correspond to their locations on the IW by IH image.

FIG. 5C illustrates additional detail of the output stack 506, with an example of how an output block 512 of 14×1×8 pixels represents a portion of output image 510 spanning registers S0 to S13, where each register contains 8 output channels for a single (Ox, Oy) pixel. A selection of the output block size 514 depends on the convolution processor architecture. For example, the CPU micro-architecture dictates the number of registers and the size of registers, such as the Intel Haswell architecture, which uses AVx2 vector units and 16 registers of 8 values. In a typical embodiment the size 514 of the output block can be computed in a single step.

FIG. 5D illustrates additional detail of the selection of the input block size. For example, for the output block size 512 of 1×14×8 channels in a 16×1×8 block, and a convolution weight 504 having size 3×3 (kW×kH), then an input block 516 of size 16×3×1 is selected for optimal convolution processing.

FIG. 5E illustrates additional details of the input image packing 520 processing. For example, for input block 516 having an input channels IC 503 the operations for processing all pixels for one block of 16×1 pixels is shown, and is repeated for each such block of pixels.

FIG. 5F illustrates additional details of the convolution weights packing 522, in which the weights 504 (FIG. 5A) having IC·OC convolution kernels 505 are weighted for IC channels 503 and OC channels 507 to generate a total of kW·kH·IC·OC values. For example, the weights packing 522 is repeated for o=8 . . . 15, o=16 . . . 23, . . . etc. to generate 72×IC values for a weight matrix with dimensions kW=kH=3, and an OC=8, depending on the size of the convolution processor architecture.

FIG. 5G illustrates additional details of the multilayer convolution computations 528 to apply packed convolution weights 522 to packed input 524 to generate output blocks 512. As shown, registers S0 through S13 are used to accumulate the 16×8 output pixels as the convolution computations are repeated for each input channel.

Any one of the methods described herein can be implemented on a variety of different data processing devices, including general purpose computer systems, special purpose computer systems, etc. For example, the data processing systems which may use any one of the methods described herein may include a desktop computer or a laptop computer or a tablet computer or a smart phone, or a cellular telephone, or a personal digital assistant (PDA), an embedded electronic device or a consumer electronic device.

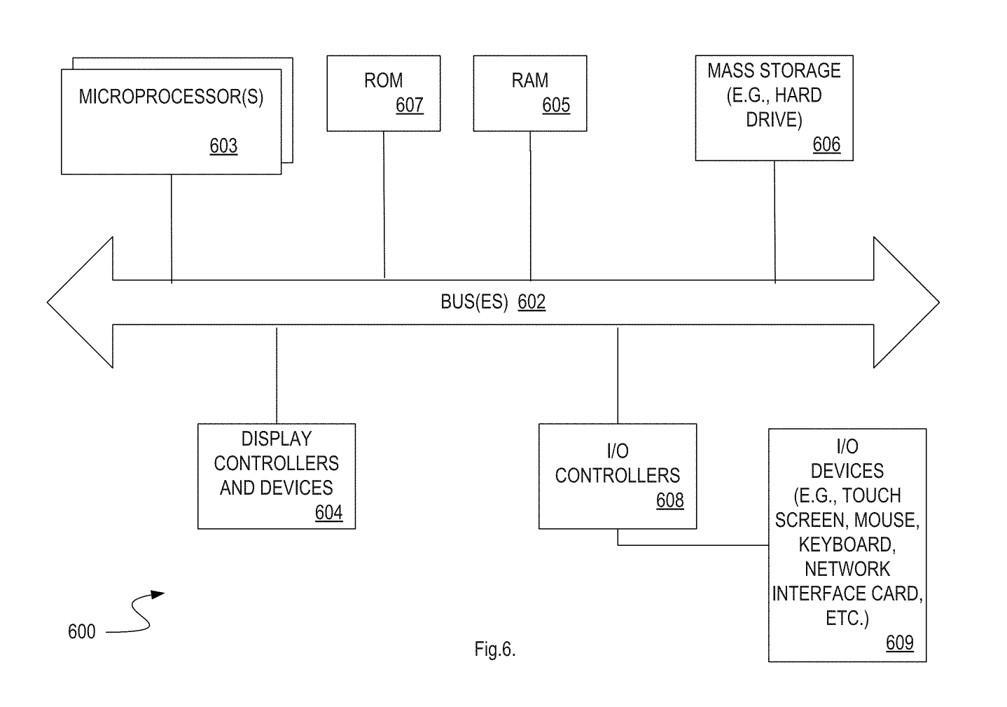

FIG. 6 shows one example of a typical data processing system which may be used with the present invention. Note that while FIG. 6 illustrates the various components of a data processing system, such as a computer system, it is not intended to represent any particular architecture or manner of interconnecting the components as such details are not germane to the present invention. It will also be appreciated that other types of data processing systems which have fewer components than shown or more components than shown in FIG. 6 may also be used with the present invention. The data processing system of FIG. 6 may be, for example, an iOS device such as an iPhone, or a Macintosh computer from Apple Inc. of Cupertino, Calif.

As shown in FIG. 6, the data processing system 600 includes one or more buses 602 which serve to interconnect the various components of the system. One or more processors 603 are coupled to the one or more buses 602 as is known in the art. Memory 605 may be DRAM or non-volatile RAM or may be flash memory or other types of memory. This memory is coupled to the one or more buses 602 using techniques known in the art.

The data processing system 600 can also include non-volatile memory 607 which may be a hard disk drive or a flash memory or a magnetic optical drive or magnetic memory or an optical drive or other types of memory systems which maintain data even after power is removed from the system. The non-volatile memory 607 and the memory 605 are both coupled to the one or more buses 602 using known interfaces and connection techniques.

A display controller 604 is coupled to the one or more buses 602 in order to receive display data to be displayed on a display device 609 which can display any one of the user interface features or embodiments described herein. The display device 609 can include an integrated touch input to provide a touch screen.

The data processing system 600 can also include one or more input/output (I/O) controllers 608 which provide interfaces for one or more I/O devices, such as one or more mice, touch screens, touch pads, joysticks, and other input devices including those known in the art and output devices (e.g. speakers). The input/output devices 609 are coupled through one or more I/O controllers 608 as is known in the art.

While FIG. 6 shows that the non-volatile memory 607 and the memory 605 are coupled to the one or more buses directly rather than through a network interface, it will be appreciated that the data processing system may utilize a non-volatile memory which is remote from the system, such as a network storage device which is coupled to the data processing system through a network interface such as a modem or Ethernet interface or wireless interface, such as a wireless WiFi transceiver or a wireless cellular telephone transceiver or a combination of such transceivers.

As is known in the art, the one or more buses 602 may include one or more bridges or controllers or adapters to interconnect between various buses. In one embodiment, the I/O controller 608 includes a USB adapter for controlling USB peripherals and can control an Ethernet port or a wireless transceiver or combination of wireless transceivers.

It will be apparent from this description that aspects of the present invention may be embodied, at least in part, in software. That is, the techniques and methods described herein may be carried out in a data processing system in response to its processor executing a sequence of instructions contained in a tangible, non-transitory memory such as the memory 605 or the non-volatile memory 607 or a combination of such memories, and each of these memories is a form of a machine readable, tangible storage medium. In various embodiments, hardwired circuitry may be used in combination with software instructions to implement the present invention. Thus the techniques are not limited to any specific combination of hardware circuitry and software or to any particular source for the instructions executed by the data processing system.

Portions of what was described above may be implemented with logic circuitry such as a dedicated logic circuit or with a microcontroller or other form of processing core that executes program code instructions. Thus processes taught by the discussion above may be performed with program code such as machine-executable instructions that cause a machine that executes these instructions to perform certain functions. In this context, a “machine” may be a machine that converts intermediate form (or “abstract”) instructions into processor specific instructions (e.g. an abstract execution environment such as a “virtual machine” (e.g. a Java Virtual Machine), an interpreter, a Common Language Runtime, a high-level language virtual machine, etc.), and/or, electronic circuitry disposed on a semiconductor chip (e.g. “logic circuitry” implemented with transistors) designed to execute instructions such as a general-purpose processor and/or a special-purpose processor. Processes taught by the discussion above may also be performed by (in the alternative to a machine or in combination with a machine) electronic circuitry designed to perform the processes (or a portion thereof) without the execution of program code.

An article of manufacture may be used to store program code. An article of manufacture that stores program code may be embodied as, but is not limited to, one or more memories (e.g. one or more flash memories, random access memories (static, dynamic or other)), optical disks, CD-ROMs, DVD ROMs, EPROMs, EEPROMs, magnetic or optical cards or other type of machine-readable media suitable for storing electronic instructions. Program code may also be downloaded from a remote computer (e.g. a server) to a requesting computer (e.g. a client) by way of data signals embodied in a propagation medium (e.g. via a communication link (e.g. a network connection)).

The term “memory” as used herein is intended to encompass all volatile storage media, such as dynamic random access memory (DRAM) and static RAM (SRAM). Computer-executable instructions can be stored on non-volatile storage devices 606, such as magnetic hard disk, an optical disk, and are typically written, by a direct memory access process, into memory during execution of software by a processor. One of skill in the art will immediately recognize that the term “machine-readable storage medium” includes any type of volatile or non-volatile storage device that is accessible by a processor.

The preceding detailed descriptions are presented in terms of algorithms and symbolic representations of operations on data bits within a computer memory. These algorithmic descriptions and representations are the tools used by those skilled in the data processing arts to most effectively convey the substance of their work to others skilled in the art. An algorithm is here, and generally, conceived to be a self-consistent sequence of operations leading to a desired result. The operations are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be kept in mind, however, that all of these and similar terms are to be associated with the appropriate physical quantities and are merely convenient labels applied to these quantities. Unless specifically stated otherwise as apparent from the above discussion, it is appreciated that throughout the description, discussions utilizing terms such as “processing” or “computing” or “calculating” or “determining” or “displaying” or the like, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

The present invention also relates to an apparatus for performing the operations described herein. This apparatus may be specially constructed for the required purpose, or it may comprise a general-purpose computer selectively activated or reconfigured by a computer program stored in the computer. Such a computer program may be stored in a computer readable storage medium, such as, but is not limited to, any type of disk including floppy disks, optical disks, CD-ROMs, and magnetic-optical disks, read-only memories (ROMs), RAMs, EPROMs, EEPROMs, magnetic or optical cards, or any type of media suitable for storing electronic instructions, and each coupled to a computer system bus.

The processes and displays presented herein are not inherently related to any particular computer or other apparatus. Various general-purpose systems may be used with programs in accordance with the teachings herein, or it may prove convenient to construct a more specialized apparatus to perform the operations described. The required structure for a variety of these systems will be evident from the description below. In addition, the present invention is not described with reference to any particular programming language. It will be appreciated that a variety of programming languages may be used to implement the teachings of the invention as described herein.

In the foregoing specification, the invention has been described with reference to specific exemplary embodiments thereof. It will be evident that various modifications may be made thereto without departing from the broader spirit and scope of the invention as set forth in the following claims. The specification and drawings are, accordingly, to be regarded in an illustrative sense rather than a restrictive sense.

What is claimed is:

1. A computer-implemented method of managing data for convolution processing, the method comprising:
in a device having:
a memory,
an input channel for receiving a stack of input data,
an output channel for receiving a stack of output data, and
a convolution kernel containing a stack of weights for convolving the stack of input data into the stack of output data;
packing the input stack into a continuous block of memory,
packing the convolution kernel into a continuous block of memory, and
unpacking the output stack based on the architecture of the device; and
convolving the input stack into the output stack using the stack of weights in the convolution kernel.

2. A computer-implemented method as in claim 1, wherein packing the input stack into the continuous block of memory includes:
reading all input blocks in the input stack corresponding to a portion of the input data; and
arranging all of the input blocks into the continuous block of memory.

3. A computer-implemented method as in claim 2, wherein the portion of the input data to which the input blocks correspond is one or more input pixels and their neighboring pixels.

4. A computer-implemented method as in claim 1, wherein packing the output stack based on the architecture of the device is allocating a set of output blocks in the output stack to use a maximum number of registers, the set of output blocks in the output stack corresponding to the portion of input data being convolved.

5. A computer-implemented method as in claim 4, wherein the portion of input data being convolved is any one of a continuous row and a continuous column of input pixels.

6. A computer-implemented method as in claim 4, wherein convolving the input stack into the output stack includes:
loading into memory the stack of weights corresponding to the portion of input data;
arranging the loaded weights into a convolution weight matrix;
calculating each value in the allocated set of output blocks in the output stack from the corresponding values in the input blocks and the convolution weight matrix.
